(19) United States
(12) Patent Application Publication
(10) Pub. No.: US 2005/0150388 A1
(43) Pub. Date: Jul. 14, 2005

(54) Modular food guards and post-flange assemblies for same

(76) Inventor: Jose Orlando Matus JR., Gainesville, GA (US)

Correspondence Address: GARDNER GROFF, P.C., 2018 POWERS FERRY ROAD, SUITE 800, ATLANTA, GA, 30339, US

(21) Appl. No.: 10/965,375

(22) Filed: Oct. 14, 2004

Related U.S. Application Data
(60) Provisional application No. 60/511,160, filed on Oct. 14, 2003.

(51) Int. Cl. A23L 1/00

(52) U.S. Cl. 99/275

(57) ABSTRACT

A modular system for assembling food guards, including a support post and flanges. The system can also include brackets, shields and shelves. The system can be provided as a kit. A support post comprises a solid rod with a threaded opening in at least one end. A support post of the invention fits with any of the flanges and can be used to assemble various food guard embodiments depending on the desired application and surface for attachment.

### CROSS-REFERENCE TO RELATED APPLICATIONS

This application claims priority to U.S. Provisional Application Ser. No. 60/511,160, filed Oct. 14, 2003, hereby incorporated by reference in its entirety for all its teachings.

### TECHNICAL FIELD OF THE INVENTION

The present invention relates to food guards and, more particularly, to a support post design that can be used with different flange/mounting base designs and that can be mounted to virtually any type of surface.

### BACKGROUND OF THE INVENTION

Most food guards sold today use tubular support posts that are secured to flanges/mounting bases by means of welding, soldering, adhesives, and/or screws. The flanges are secured to the support post, and the way in which they are secured to the post typically depends on the nature of the support. In most cases, the support post and flange are of similar alloys, namely brass, stainless steel or aluminum. When the post and flange are of similar alloy, they are most often welded, soldered or brazed together to form a permanent bond. If the support post and flange are of different materials, they are most often secured by means of a threaded fastener that passes through the side (collar) of the flange and into the tubular support post. In this manner of attachment, a metal adhesive is used in combination with the mechanical fasteners. In other instances, the end of the support post may have male threads and it mechanically fastens to a flange or base that is has internal threads of the same pitch and size. Again, this is primarily used in conjunction with a metal adhesive.

After a flange is secured to a support post, the assembly goes through a finishing process, usually polishing, plating, and/or powder coating (a paint process). After the finishing process, the post-flange assembly is ready for on-site installation. The post-flange assembly is then fastened to a surface, usually a cabinet or some sort of casework, but in some instances a ceiling, soffit or wall. Some of the surfaces that food guard support posts are mounted to include stainless steel, marble, granite, tile, glass, laminated wood, hardwood and solid-surface materials such as Corian® or Avonite®. Once the flange/base has been secured to a support post and shipped to a customer or job-site for installation, it generally cannot be removed and replaced with a different type of flange/base for a variety of reasons. In most cases the flange/base and the support post are welded or soldered together and are impossible to remove without damaging the surface finish of the flange and support post. If the new post-flange assembly is secured to the surface at a different location on the surface, the alterations to the surface caused by securing the previous post-flange assembly to it will be noticeable. This may be detrimental to the aesthetic appearance of the surface.

In addition, securing the new post-flange assembly to a different location on the surface means additional alterations to the surface, which may be detrimental to the structural integrity of the surface. This essentially eliminates the possibility of changing out one post-flange assembly design for another. It would be desirable to be able to swap out one post-flange design for another to give a sneeze guard a new or different look. Furthermore, selecting a post-flange assembly typically is based at least partially on the type of surface to which the assembly is to be secured. For example, if the mounting surface is stainless steel, a flange that is designed to be secured with screws would not be selected. One of the disadvantages of this interdependence is that post-flange assemblies are limited with respect to the mounting surface types they can be used with, which, in turn, limits the variability of food guard designs.

Also, if the flange/base hardware is not compatible with the mounting surface, merely ordering different flange/base hardware that is compatible with the mounting surface is not a viable option. As stated above, the flange/base is typically secured to the support post either by welding or soldering, or by mechanical coupling in conjunction with adhesive. Therefore, separating the flange/base from the post and securing a different flange/base to the post generally is not practical. Consequently, if the post-flange assembly is not compatible with the mounting surface, a different post-flange assembly normally must be ordered. Furthermore, in most cases, this compatibility issue makes it impractical to remove a post-flange assembly from one food guard system and mount it on a different food guard surface.

It would be desirable to provide post-flange assemblies with flanges that can be swapped without having to change the post in order to achieve a greater variety of post-flange assembly designs. It would also be desirable to provide post-flange assemblies that are suitable for mounting to different types of surfaces so that the selection of the post-flange assembly is less dependent or independent of the surface to which it will be secured.

### SUMMARY OF THE INVENTION

The present invention provides a “LEGO”®-type/modular set of components for assembling food guards.

A support post of a food guard is disclosed, the post being essentially solid, having two ends, and having at least one end with a threaded opening therein.

Also disclosed is a flange that couples to the support post of the invention by means of a threaded fastener that secures directly to the threaded opening of the support post.

Further disclosed is a modular system for assembling food guards comprising at least one support post wherein the support post comprises a solid rod having two ends and having at least one threaded opening in at least one end, at least one flange, wherein the at least one flange is configured to be removably secured to the at least one support post.

The invention also includes a kit for assembling food guards comprising at least one solid support post having two ends, and having at least one end with a threaded opening therein, at least one flange, at least one bracket, at least one shield or shelf, wherein the flange, bracket, and shield or shelf are configured to be removably secured to the at least one support post interchangeably.

The invention also includes the assembled food guard comprising at least one solid support post having two ends, and having at least one end with a threaded opening therein, at least one flange, at least one bracket, at least one shield or shelf, wherein the flange, bracket, and shield or shelf are configured to be removably secured to the at least one support post interchangeably.

Still further included are methods for using the apparatuses of the invention. A method of converting a modular food guard from a first configuration to a second configuration, comprising providing a modular system for assembling food guards comprising at least one support post wherein the support post comprises a solid rod having two ends and having at least one threaded opening in at least one end, at least one flange, wherein the at least one flange is configured to be removably secured to the at least one support post; removing undesired components of the first configuration of the food guard; re-assembling and/or replacing the components of the food guard using components from the modular system thereby forming a second configuration of a food guard is disclosed. Also a method of assembling a modular food guard comprising providing a modular system for assembling food guards comprising at least one support post wherein the support post comprises a solid rod having two ends and having at least one threaded opening in at least one end, at least one flange, wherein the at least one flange is configured to be removably secured to the at least one support post; attaching components of the modular system together in a desired end configuration of a food guard is disclosed.

An advantage of the present invention is that it allows for complete flexibility before, during and after installation of food guard support posts. The post design allows the interaction of several flange styles, shapes and sizes. The flange designs allow for complete flexibility on-site, no matter what the size and shape may be. Because of the method of fastening the flange to the support post, there is no damage incurred to the surface integrity of either the flange or the support post.

Additional advantages are discussed below and will be apparent to one of skill in the art from the description herein.

### BRIEF DESCRIPTION OF THE DRAWINGS

The accompanying drawings, which are incorporated in and constitute a part of this specification, illustrate several aspects described below. Like numbers represent the same elements throughout the figures.

FIG. 1 shows an embodiment of the support post and a spacer of the present invention.

FIG. 2B-E shows various embodiments of flanges of the present invention.

FIG. 3A-E, G-I shows various embodiments of flanges of the present invention.

FIG. 4A-I shows various embodiments of flanges of the present invention.

FIG. 5 shows an embodiment of an above counter with pass-through flange surface mount using a support post and flange 4A.

FIG. 6 shows an embodiment of an above counter surface mount using a support post and flange 4F.

FIG. 7 shows an embodiment of an above and below counter concealed mount using a support post and flanges 4D (top) and 4A (bottom).

FIG. 8 shows an embodiment of a concealed mount using a support post and flanges 4D (top) and 4F (bottom).

FIG. 9 shows an embodiment of a concealed mount using a support post and flanges 4G (top) and 3A (bottom).

FIG. 10 shows an embodiment of a concealed mount using a support post and flanges 4D (top), 4A (middle), and 4A (bottom).

FIG. 11 shows an embodiment of a concealed mount using a support post and flanges 3C (top) and 4F (bottom).

FIG. 12 shows an embodiment of a concealed mount using a support post and flanges 3C (top) and 4F (bottom).

FIG. 13 shows an embodiment of a concealed mount using a support post and flanges 3C (top) and 4F (bottom).

FIG. 14 shows an embodiment of a surface mount using a support post and flange 4A.

FIG. 15 shows an embodiment of a surface mount using a support post and flange 4B.

FIG. 16 shows an embodiment of a concealed mount using a support post and flange 4G.

FIG. 17 shows an embodiment of a concealed mount using a support post and flanges 4D (top), 3C (middle), and 4F (bottom).

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise.

All food guards require support posts in order to bear the weight of the clear glass or acrylic see-through panels and/or lights and food warmers. The conventional support posts are generally a tubular, corrosion-resistant material, namely brass, aluminum or stainless steel. In order for a tubular support to be mounted to a surface, usually laminated wood, marble, granite, tile, hardwood, or solid-surface polymer materials, the support requires mounting hardware commonly referred to as a base or flange. This base/flange couples to the tubular support through various fastening methods, typically welding, soldering and/or mechanical fasteners and metal adhesives. When the base is coupled to the flange by the above-mentioned means, it generally cannot be removed without damaging the surface of either the post or the flange.

Typically, when a food guard is purchased, the purchaser specifies the type of mounting hardware required based on the intended application. When mounting a conventional food guard to a countertop or other type cabinet or millwork, the selection of the mounting hardware is critical based on: (1) the type of surface to which the food guard will be secured, (2) location of the countertop equipment and displayed food relative to the edges, sides and faces of the surface, (3) height, depth and length of the countertop equipment and its relative position to the countertop surface, and (4) location of bracing and/or blocking below the countertop surface.

In most instances the location of countertop equipment and displayed food will determine the location for the food guard supports. If there is some change from the original plans or specifications and there is not sufficient countertop space to allow for the food guard mounting hardware, typically there is no rapid solution other than to order completely new supports—this being because the flanges are secured to the support posts by a means that upon removal will damage the surface-finish of the supports. In other instances, a specification may call for a concealed-mount hardware that will mount below the countertop surface. If there is not sufficient space below the countertop, then the support must be mounted on the countertop surface.

Attempting to change the mounting hardware on-site again becomes a problem for conventional systems. The present invention eliminates or minimizes many of the drawbacks of the conventional food guard system.

An advantage of the present invention is that it allows for complete flexibility before, during and after installation of the food guard support posts. The post design allows the interchangeability of several flange styles, shapes and sizes. The flange designs allow for complete flexibility on-site, no matter what the size and shape may be. Because of the method of fastening the flange to the support post, there is no damage incurred to the surface integrity of either the flange or the support post.

The present invention provides a “LEGO”®-type, or modular, set, or system, of components for assembling food guards. The present invention includes a modular set of components for assembling a food guard and the individual pieces within the set. Also included are a kit with the modular components and a final assembled food guard.

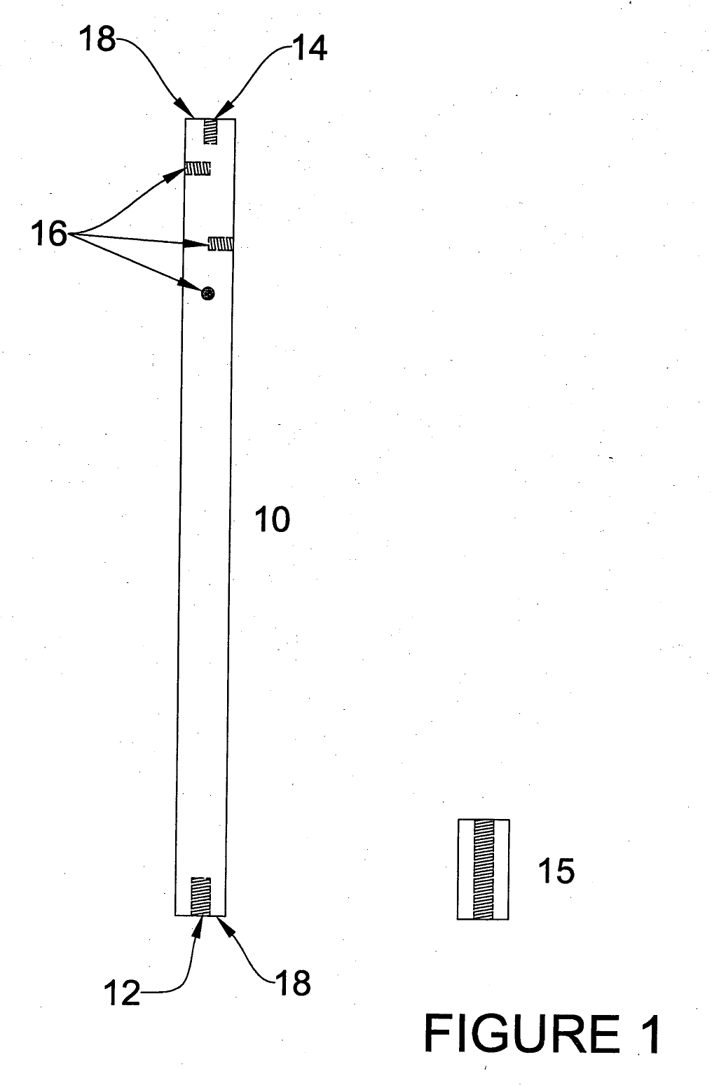

A support post 10 of the invention comprises an essentially solid rod with two ends and with a threaded opening 12 in at least one end. FIG. 1 shows an example support post 10 of the invention. The post 10 can have a threaded opening 12, 14 in each end of the post. The threaded opening(s) 12, 14 can be in the end surface(s) 18 of the post 10. The threaded opening(s) 12, 14 are adapted to receive a threaded fastener such as a screw or a bolt. As described below and illustrated in the Figures, the end(s) of the post 10 can be attached to a surface and/or at least one flange of the present invention. In a preferred embodiment, the support post 10 is cylindrical and the threaded openings 12, 14 are also cylindrical and essentially centered in the end surface(s) 18 of the post 10. The post 10 can also have additional openings 16, which may or may not be threaded, along the length of the post 10 in order to attach additional food guard components such as brackets, shields, or shelves, for example. Decorative finials (not shown) and the like can also be attached to the post 10. A finial would preferably be attached to an end of a post 10 such as by being screwed into opening 14. Support posts can also be attached to each other to make longer/taller support posts or spacers 15 can be used to provide additional length/height. Shelves or shields can be added to an end of a post in addition to along the post length.

A support post may be used vertically, horizontally or at an angle.

An alternative embodiment of the support post 10 would be a hollow or tubular post with end caps adapted for fitting in the ends of the post and containing the threaded opening(s).

A support post can be made of virtually any material, preferably a corrosion-resistant material, e.g., brass, aluminum, or stainless steel. One of skill in the art can determine a material from which to make a support post. A post can be made by methods generally known in the art for fabricating the chosen material. One of skill in the art can determine appropriate methods and dimensions for the post for a particular application. The threaded openings within the support post can be made by various methods, preferably by drilling and tapping.

A spacer 15 of the invention can be used with a support post 10 and is similar in design and fabrication, see FIG. 1. A preferred embodiment of a spacer 15 is an essentially solid length of rod with a threaded opening passing along the longitudinal axis of the post from end to end. A spacer 15 can be fabricated in various lengths.

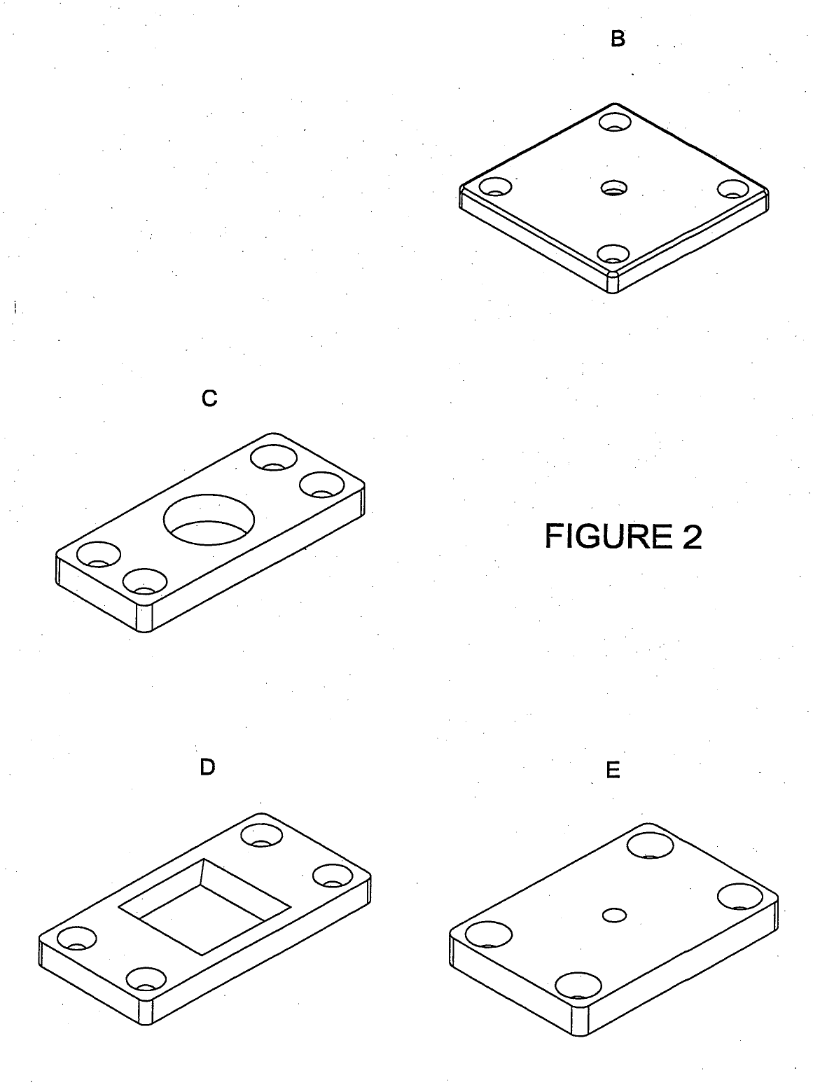

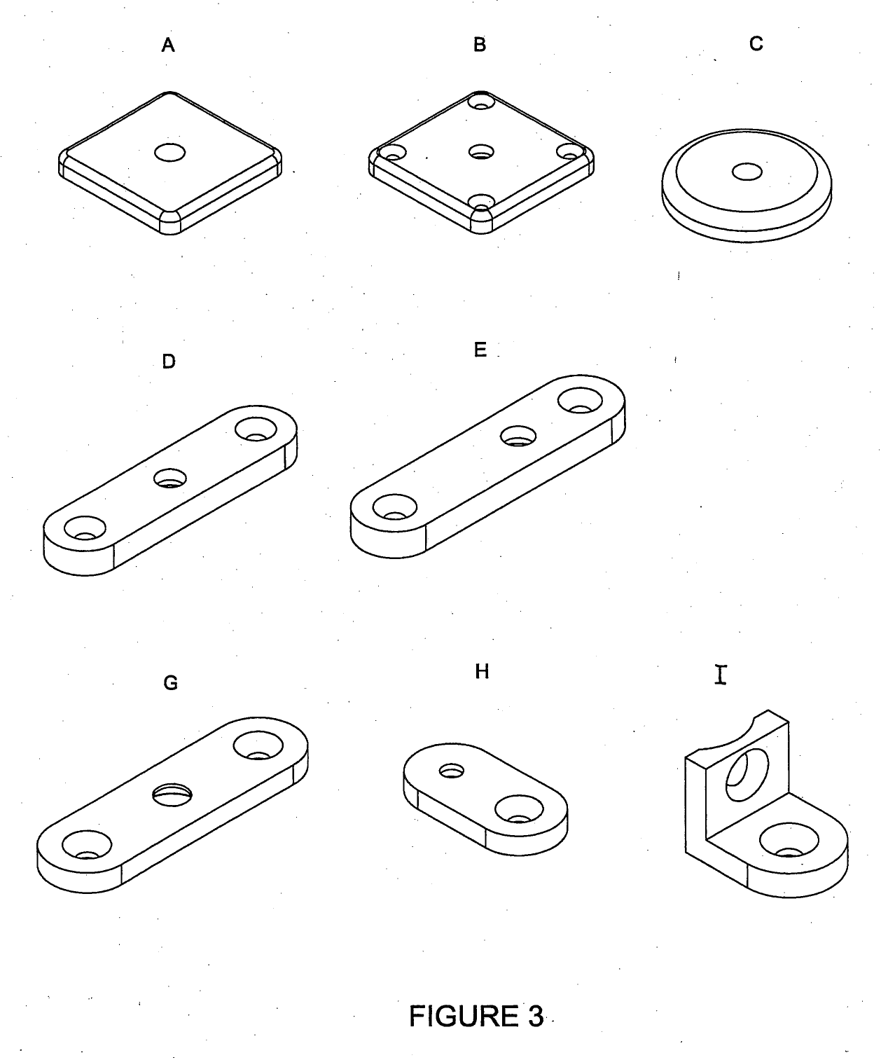

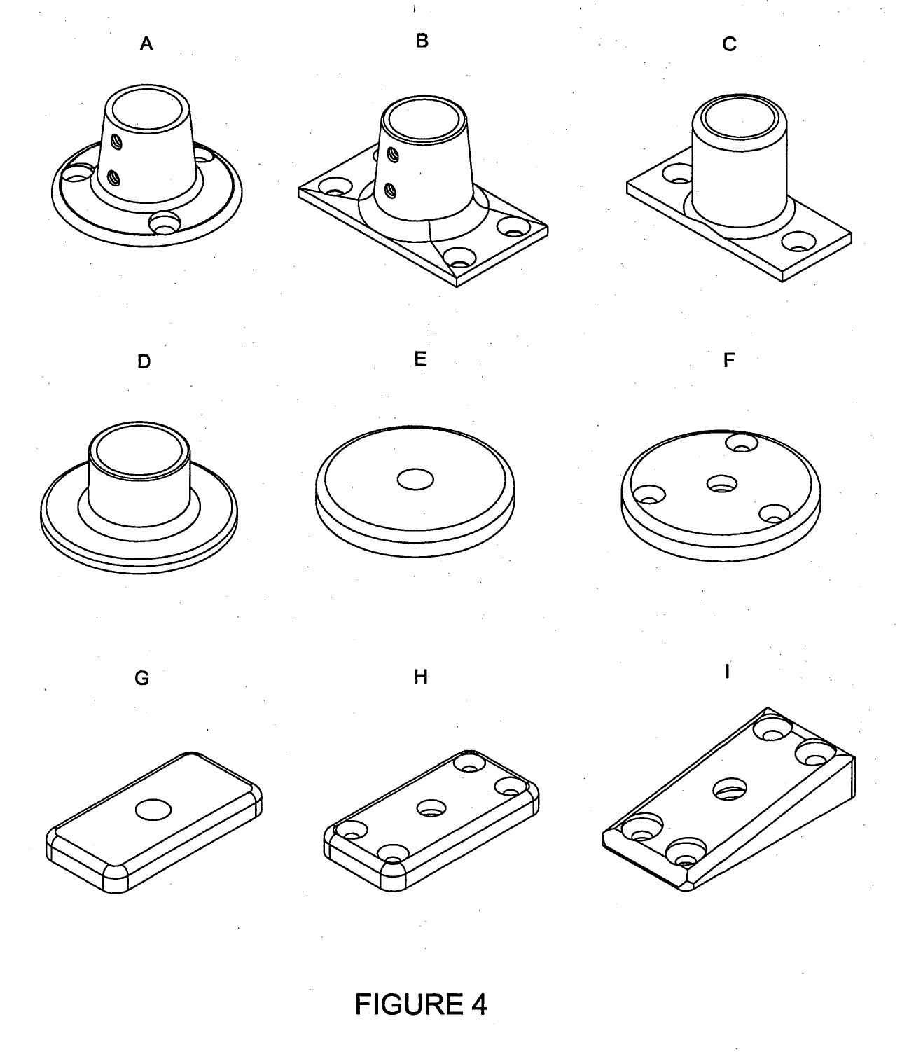

A flange 20-28 of the invention can be used with a support post 10 to mount the support post 10 in a desired location and/or position. A flange can be configured to be removably secured to the support post 10. FIGS. 2-4 show various example embodiments of flanges that can be used in the invention. As illustrated, a flange can be of various shapes and dimensions. A flange can include holes for fasteners, e.g., screws or bolts, for fastening to a surface. A flange can include an opening for passing a support post 10 of the invention. A flange can include an opening for passing a fastener for attaching a support rod 10 to the flange. A flange can include a collar for holding a support rod 10. A flange can be attached to a support post, for example, by set screws 30.

A flange can be made of a variety of materials, preferably a corrosion-resistant material, e.g., brass, aluminum, or stainless steel. One of skill in the art can determine a material from which to make a flange. A flange can be made by methods generally known in the art for fabricating parts from the selected material.

A bracket can be used in the system for attaching a shield or shelf to a support post 10 of the invention. A bracket can be configured to be removably secured to the support post 10. A bracket is also configured to be removably secured to a shelf or shield. Various conventional brackets can be used with the support post 10 of the invention. Alternatively, brackets such as described in U.S. Pat. No. 6,485,118 or U.S. Published Application 2003/0047086 A1 (which are hereby incorporated by reference for their teachings on components of food guards) can be used with the support post 10 of the invention.

A bracket can be made of a variety of materials, preferably steel, for example. One of skill in the art can determine a material from which to make a bracket. A bracket can be made by methods generally known in the art for fabricating parts from the selected material.

A shield can be used in the system of the invention. A shield can be used for the “sneeze guard” or “breath guard” in a food guard of the invention. Various conventional shields can be used with the support post 10 and hardware of the invention.

A shield can be made of a variety of materials, preferably glass, acrylic, or plexiglass, for example. A shield can be made by methods generally known in the art for fabricating a selected material.

A shelf can be used in the invention. Various conventional shelves can be used with the support post 10 and hardware of the invention.

A shelf can be made of a variety of materials, preferably glass, acrylic, or plexiglass, for example. A shelf can be made by methods generally known in the art for fabricating a selected material.

Other components in the modular system can include decorative components, such as finials, for example. Such other components can be configured to be removably secured to the support post 10.

The components of the system can be mounted to surfaces using various conventional fasteners such as screws and bolts. The support posts 10 can be attached to flanges by various means, preferably set screws 30 and other non-permanent fasteners. The shelves or shields can be mounted to the posts 10 by way of brackets (or other mounting hardware) and the brackets can be attached via pins, screws, and the like. Alternatively, shelves or shields can be directly attached to a support post 10.

In accordance with a preferred embodiment of the present invention, an end of a support post 10 that attaches to the flange has a threaded opening 12 formed in it, preferably formed by drilling and tapping, which allows the end of the support post 10 to be used with a variety of different flanges and to be secured to any one of the top of the mounting surface, the bottom of the mounting surface and beneath the bottom of the mounting surface. The variety of different mounting configurations provides great flexibility with respect to the types of mounting surfaces the post-flange assembly can be mounted to and with respect to the manner in which the post-flange assembly can be mounted to a surface and the types of flanges that can be used. In addition, the end of the post 10 opposite the end that attaches to the flange preferably has a threaded opening 14 formed therein, which preferably is formed by drilling and tapping. The Figures illustrate examples of the different post-flange assemblies and surface mounting configurations.

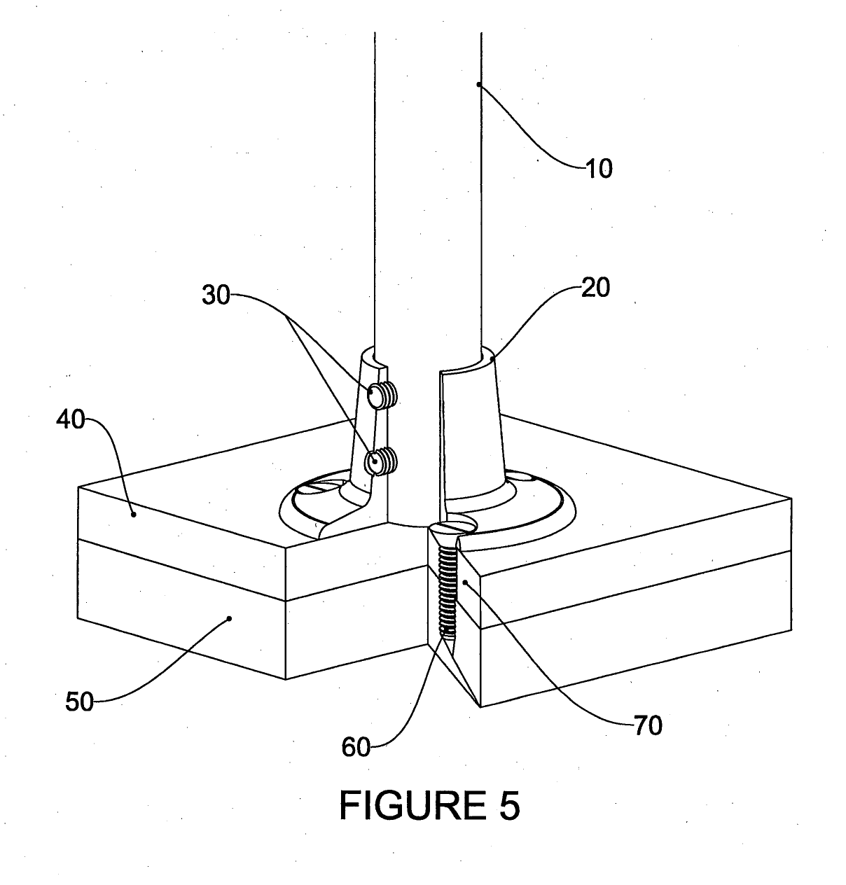

The components of the modular system can be put together in various ways depending on the desired final look and the type of surface to which the system will be mounted. For example, the system can have a below counter mount, an above counter mount, a below and through mount, an above and below mount, or an above with pass through a flange mount. Various example embodiments of installations of the invention are given in FIGS. 5-17. Additional installation configurations can be put together using the system. One of skill in the art will be able to determine appropriate combinations of the components of the system for a particular end use application.

FIG. 5 shows an example surface mount embodiment using a support post 10 and flange 20 of the present invention. The support post 10 sits on the solid surface 40, 50 in a collar of the flange 20. Set screws 30 keep the flange 20 and support post 10 from moving around. Fasteners 60, such as stainless steel screws, pass through the flange 20 and mount it to the surface 45, 50. The fasteners 60 can pass through clearance holes 70. The surface in FIG. 5 can be a solid surface top, laminate top or tile/marble top, for example. Surface 40 can be a typical solid surface and surface 50 a typical underlay.

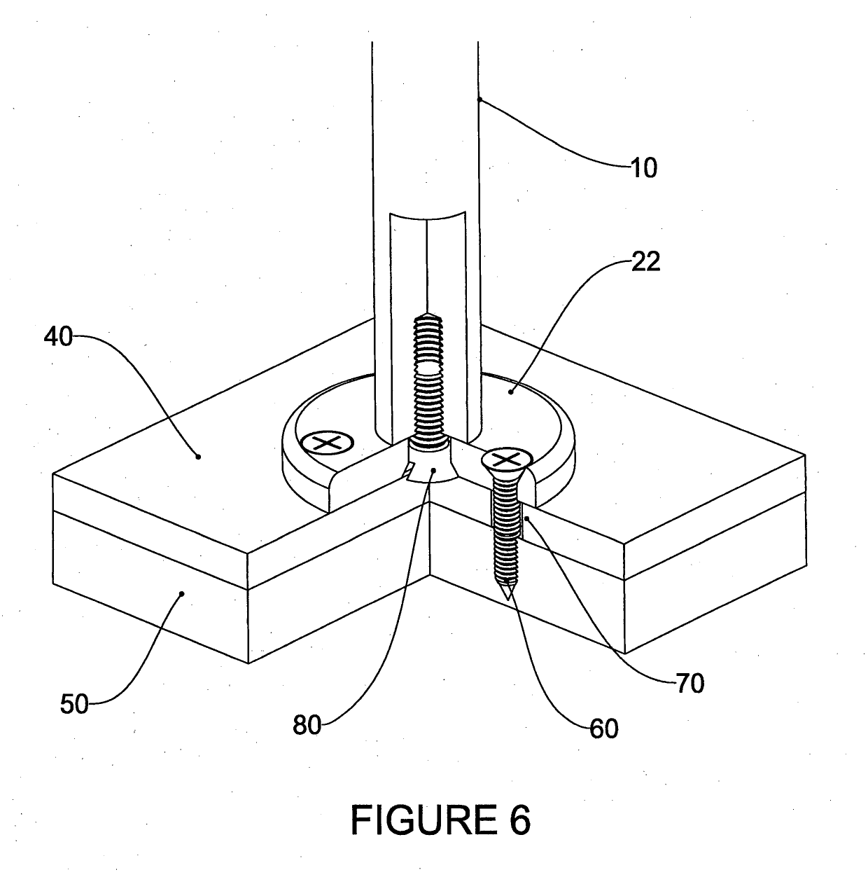

FIG. 6 shows an example surface mount embodiment using a support post 10 and flange 22 of the present invention. The support post 10 is screwed 80 to the flange 22 by, for example, a flat head hex fastener 80. The flange 22 is screwed 60, for example, to the solid surface 40, 50 to mount it. The fasteners 60 can pass through clearance holes 70. The surface in FIG. 6 can be a solid surface top, laminate top, tile/marble top, or stainless steel top, for example. Surface 40 can be a typical solid surface and surface 50 a typical underlay.

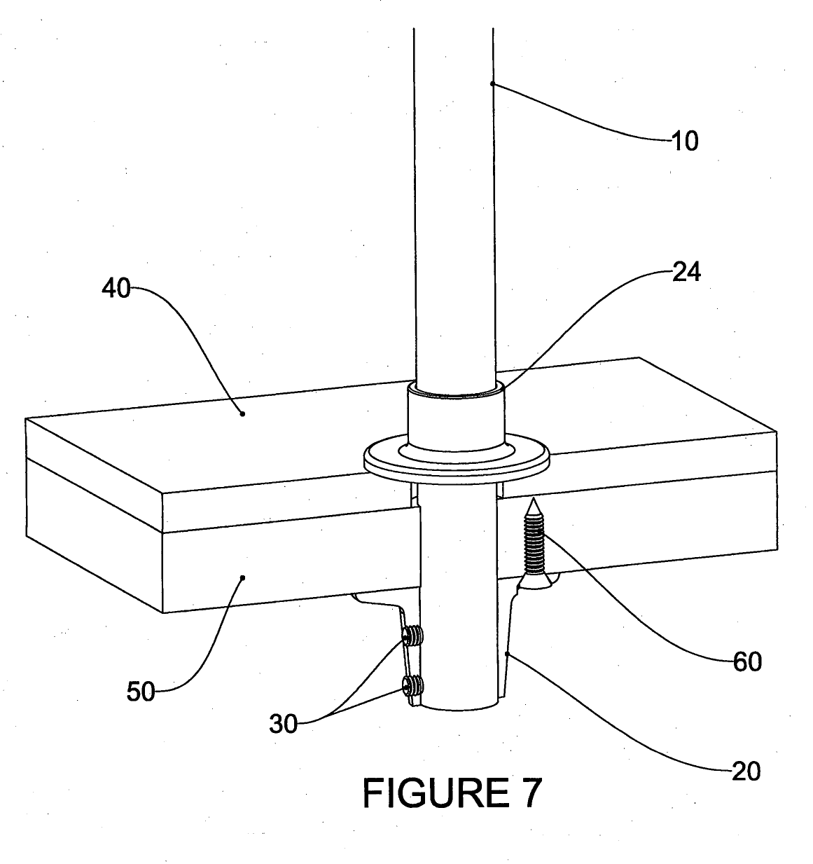

FIG. 7 shows an example concealed mount embodiment using a support post 10 and two flanges 24, 20 of the present invention. The support post 10 passes through the first flange 24 and through the solid surface 40, 50. The second flange 20 fits over the support post 10 on the bottom of the surface 50. Set screws 30, for example, attach the second flange 20 to the support rod 10. The second flange 20 is screwed 60 to the bottom of the hard surface 50. The surface in FIG. 7 can be a solid surface top, laminate top or tile/marble top, for example. Surface 40 can be a typical solid surface and surface 50 a typical underlay.

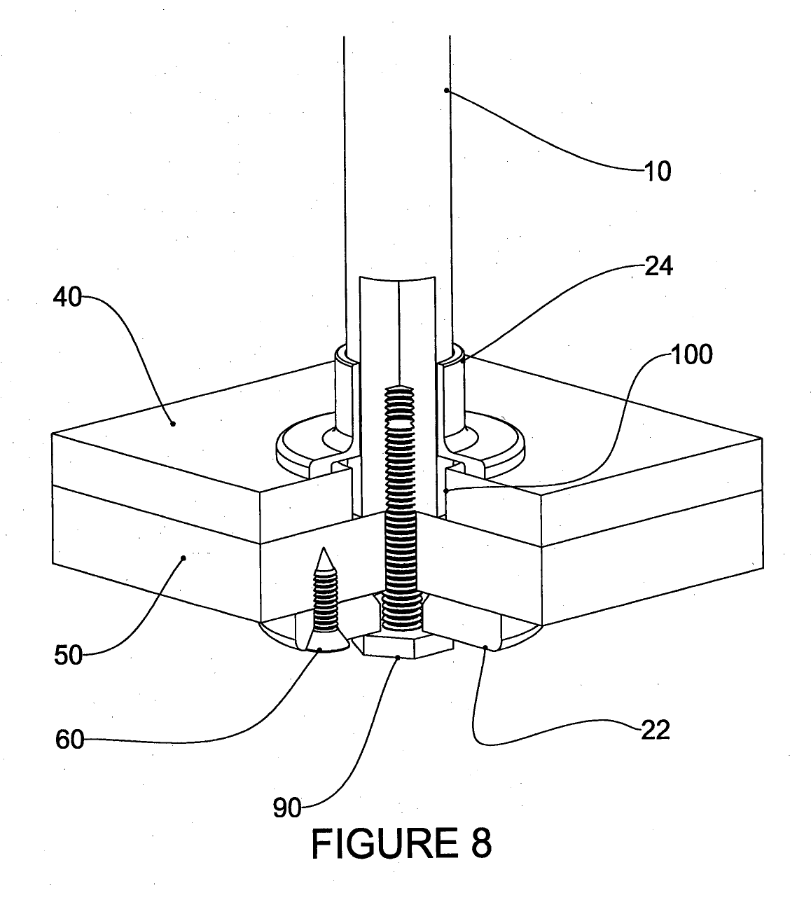

FIG. 8 shows an example concealed mount embodiment using a support post 10 passing through a first flange 24 and a first section 40 of the hard surface 40, 50 by way of a clearance hole 100. The support post 10 is attached (bolted) 90 through the hard surface 40, 50 to the second flange 22 which is on the bottom of the hard surface 50. The second flange 22 is screwed 60 to the bottom of the hard surface 50. The surface in FIG. 8 can be a solid surface top or tile/marble top, for example. Surface 40 can be a typical solid surface and surface 50 a typical underlay.

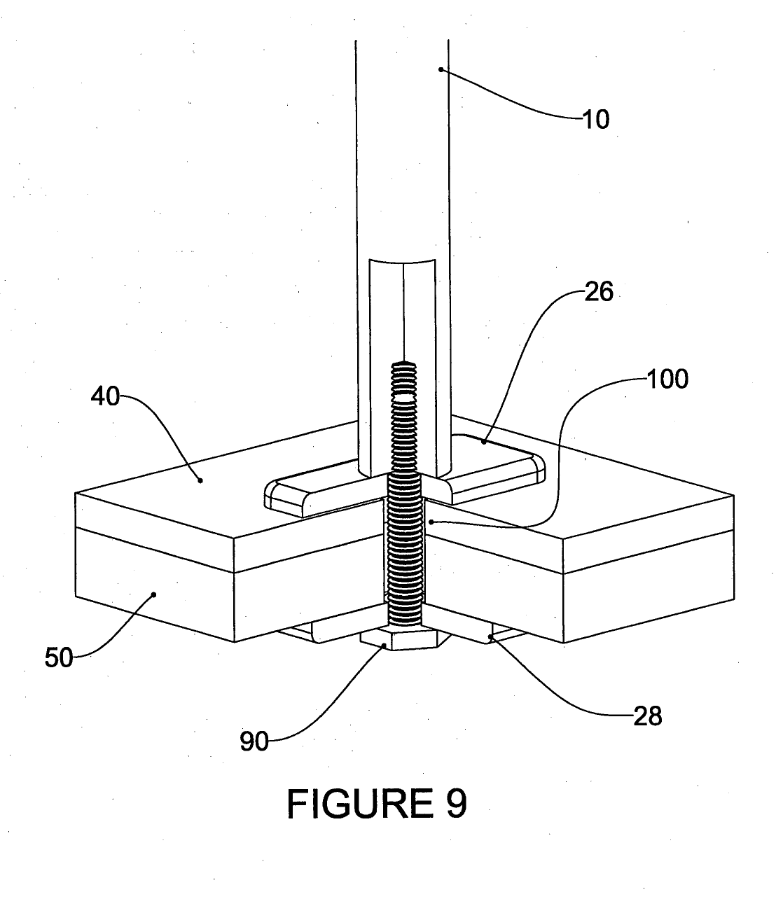

FIG. 9 shows an example concealed mount embodiment using a support post 10 of the invention sitting on top of a first flange 26 and being connected (bolted) 90 to a second flange 28 through the hard surface 40, 50 by way of a clearance hole 100. The surface in FIG. 9 can be a solid surface top, laminate top, tile/marble top, or stainless steel top, for example. Surface 40 can be a typical solid surface and surface 50 a typical underlay.

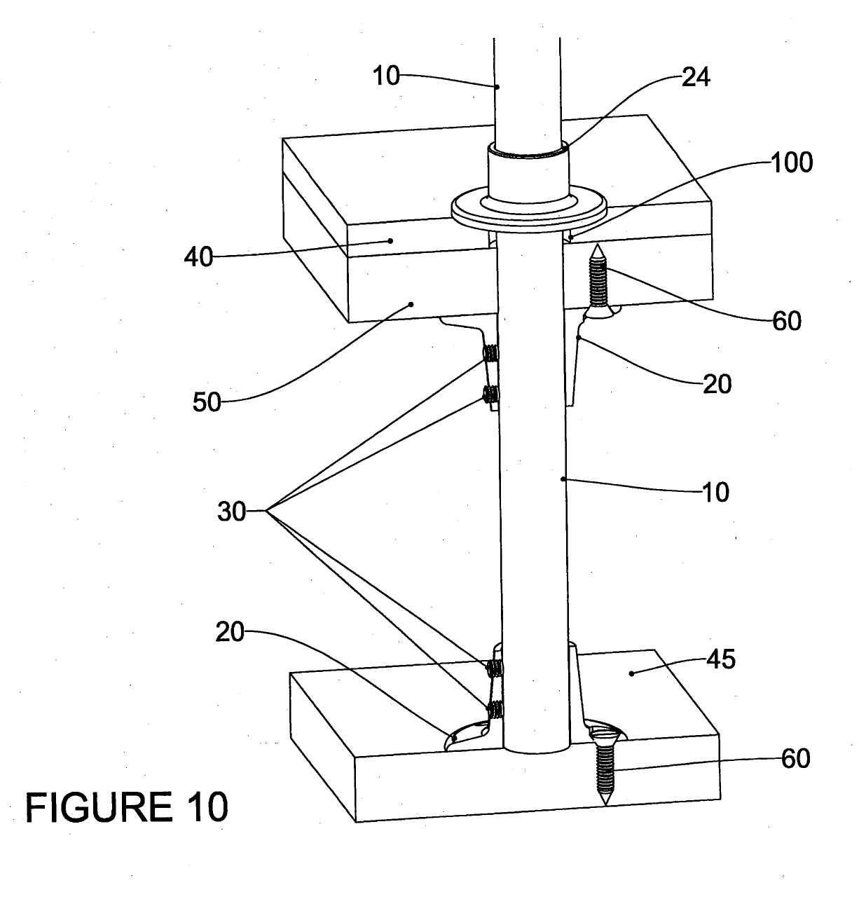

FIG. 10 shows an example concealed mount embodiment using a support post 10 passing through a first flange 24, a first hard surface 40, 50 by way of a clearance hole 100, a second flange 20, and sitting on a second hard surface 45 in a third flange 20. Set screws 30 hold the second flange 20 to the support post 10. The second flange 20 is screwed 60 to the bottom of the first hard surface 50. Set screws 30 hold the third flange 20 to the support post 10. The third flange 20 is screwed 60 to the second hard surface 45. The surfaces in FIG. 10 can be a solid surface top, laminate top, tile/marble top, or stainless steel top, for example. Surface 40 can be a typical solid surface and surface 50 a typical underlay. Surface 45 can be a cabinet base.

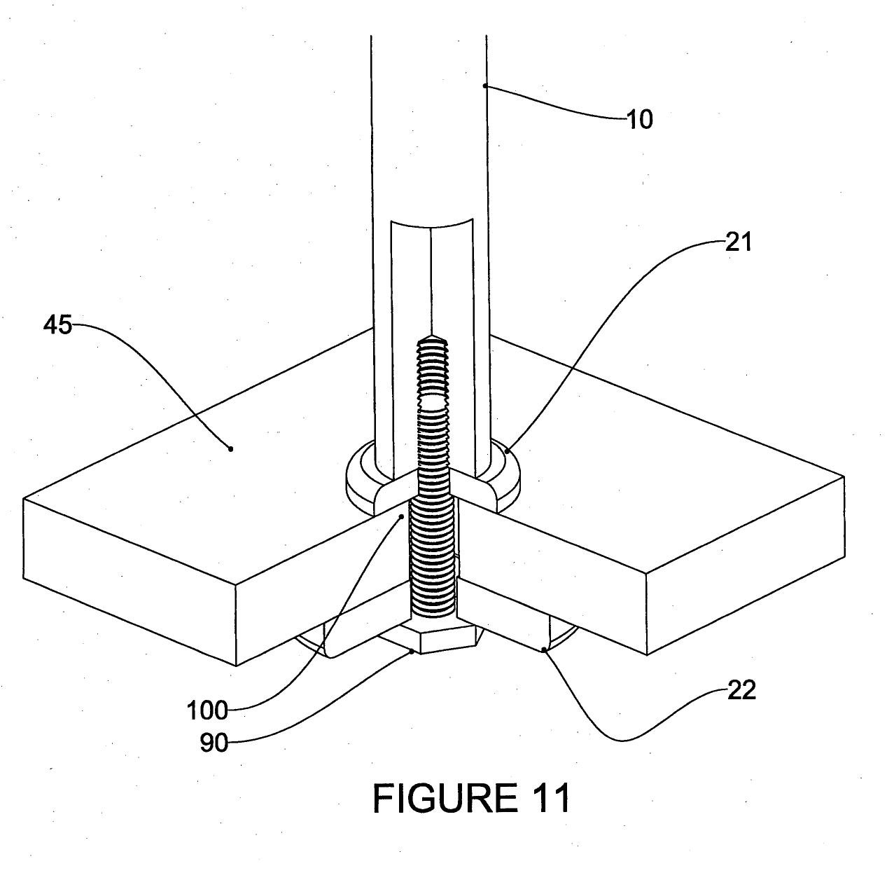

FIG. 11 shows an example concealed mount embodiment using a support post 10 sitting on a first flange 21 and connected to the first flange 21 and a second flange 22 by a bolt 90 passing through the surface 45 by way of a clearance hole 100. The second flange 22 is on the bottom of the surface 45. The surface in FIG. 11 can be a solid surface top, laminate top, tile/marble top, or stainless steel top, for example. Surface 45 can be a typical mounting surface.

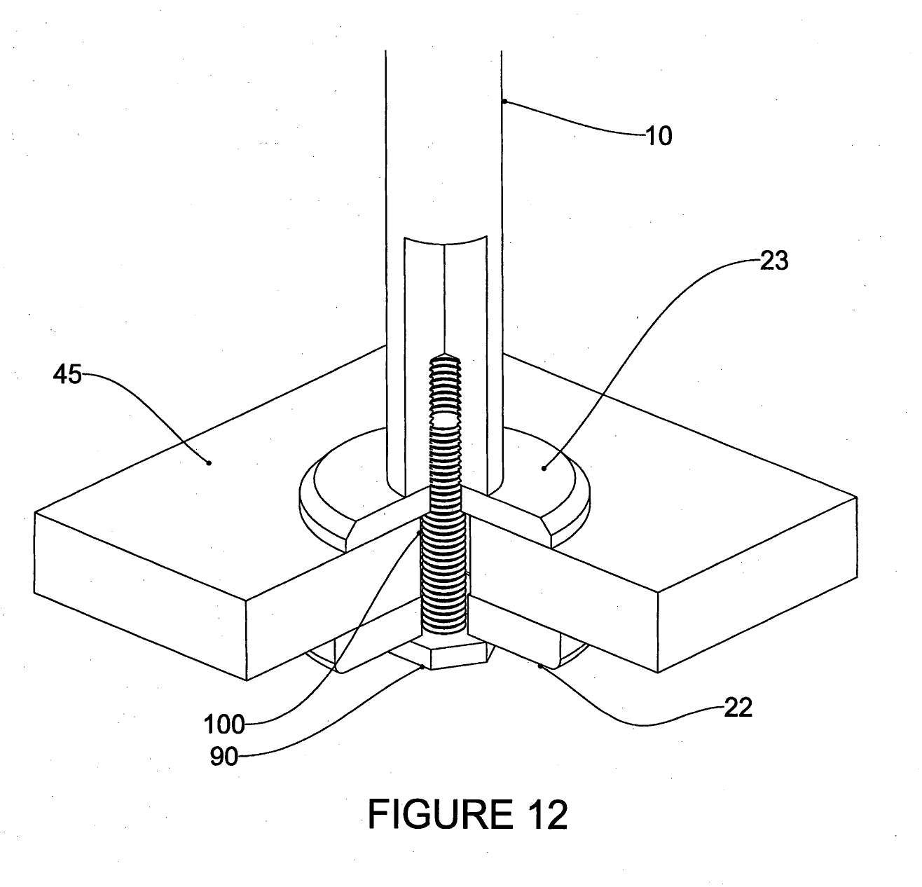

FIG. 12 shows an example concealed mount embodiment using a support post 10 sitting on a first flange 23 and connected to the first flange 23 and a second flange 22 by a bolt 90 passing through the surface 45 by way of a clearance hole 100. The second flange 22 is on the bottom of the surface 45. This is almost identical to FIG. 11 other than the first (top) flange 23 is larger in diameter in FIG. 12. The surface in FIG. 12 can be a solid surface top, laminate top, tile/marble top, or stainless steel top, for example. Surface 45 can be a typical mounting surface.

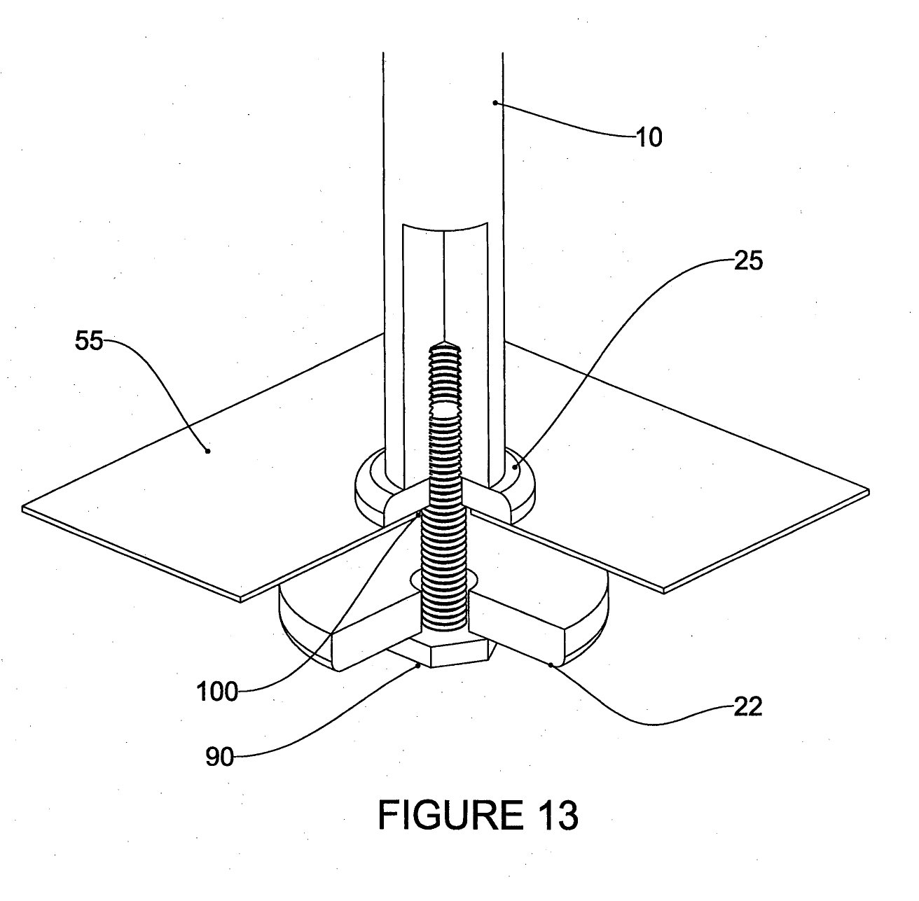

FIG. 13 shows an example concealed mount embodiment using a support post 10 sitting on a first flange 25 and connected to the first flange 25 and a second flange 22 by a bolt 90 passing through the surface 55 by way of a clearance hole 100. The second flange 22 is below the surface 55. The surface in FIG. 13 can be a stainless steel top, for example. Surface 55 can be a stainless steel sheet.

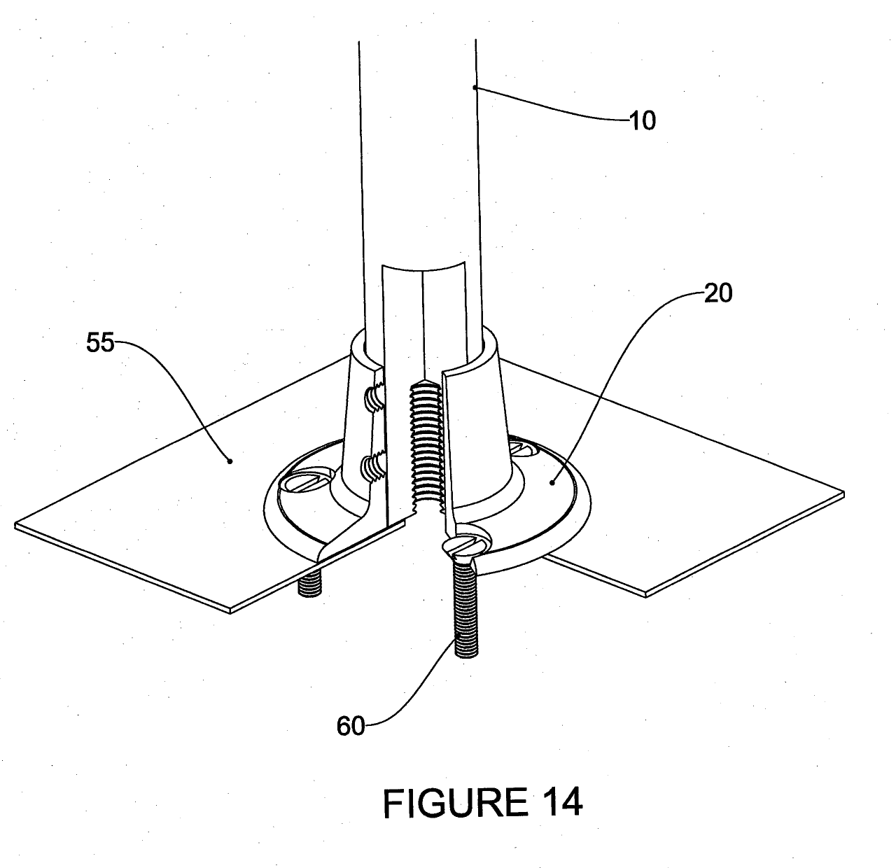

FIG. 14 shows an example surface mount embodiment using a support post 10 and flange 20 of the present invention. The support post 10 passes through the flange 20 and sits on the surface 55. The flange 20 can be attached to the post 10 with set screws 30 (not shown) or the post 10 can simply sit in the collar of the flange 20. The flange 20 is attached to the surface 55 with screws 60. The surface in FIG. 14 can be a stainless steel top, for example. Surface 55 can be a stainless steel sheet.

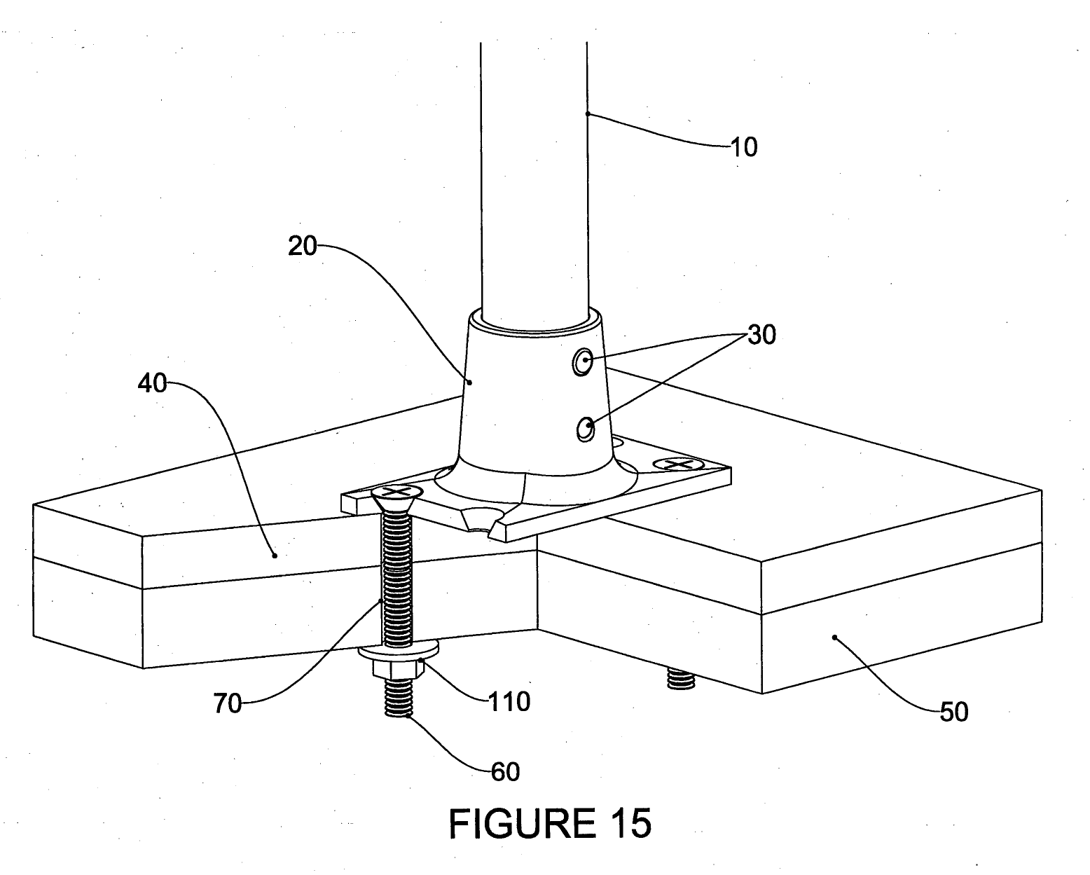

FIG. 15 shows an example surface mount embodiment using a support post 10 and flange 20 of the present invention. The support post 10 passes through the flange 20 and sits on the surface 40. The flange 20 is attached to the post 10 with set screws 30. The flange 20 is attached to the surface 40 with screws 60 and lock washer/nut 110 combinations. The screws 60 pass through a clearance hole 70. The surface in FIG. 15 can be a solid surface top, laminate top or tile/marble top, for example. Surface 40 can be a typical solid surface and surface 50 a typical underlay.

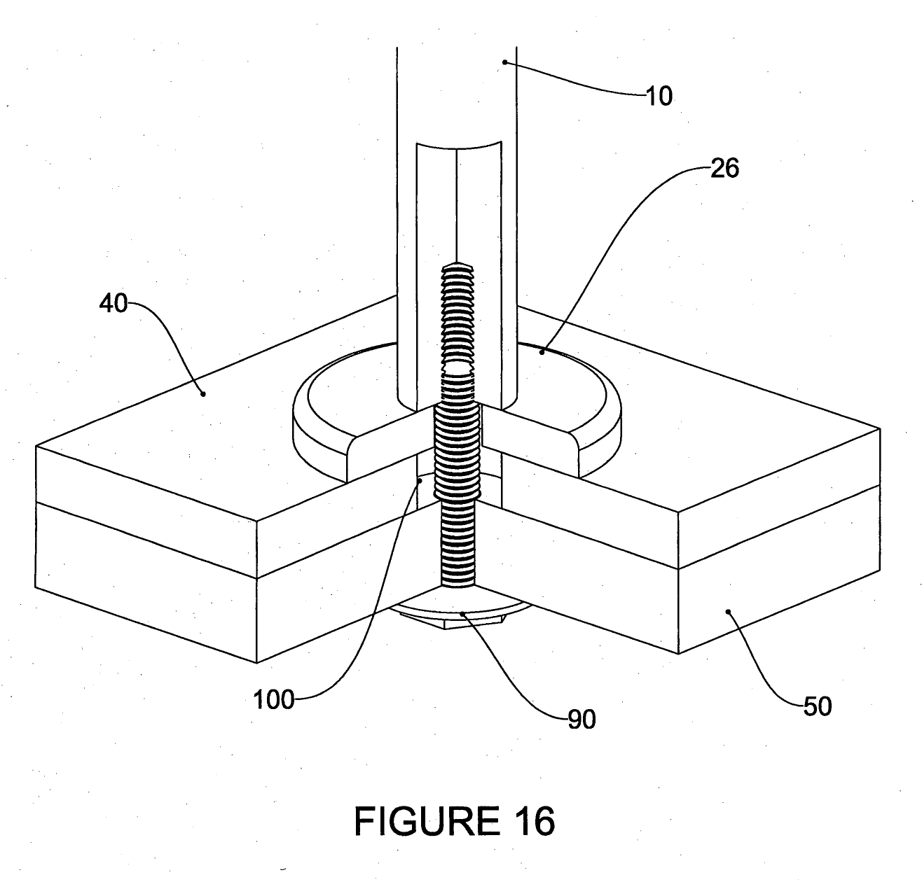

FIG. 16 shows an example concealed mount embodiment using a support post 10 sitting on a first flange 26 and connected to the first flange 26 and the surface 40, 50 by a bolt 90 passing through the surface 40, 50 by way of a clearance hole 100. The surface in FIG. 16 can be a solid surface top, laminate top or tile/marble top, for example. Surface 40 can be a typical solid surface and surface 50 a typical underlay

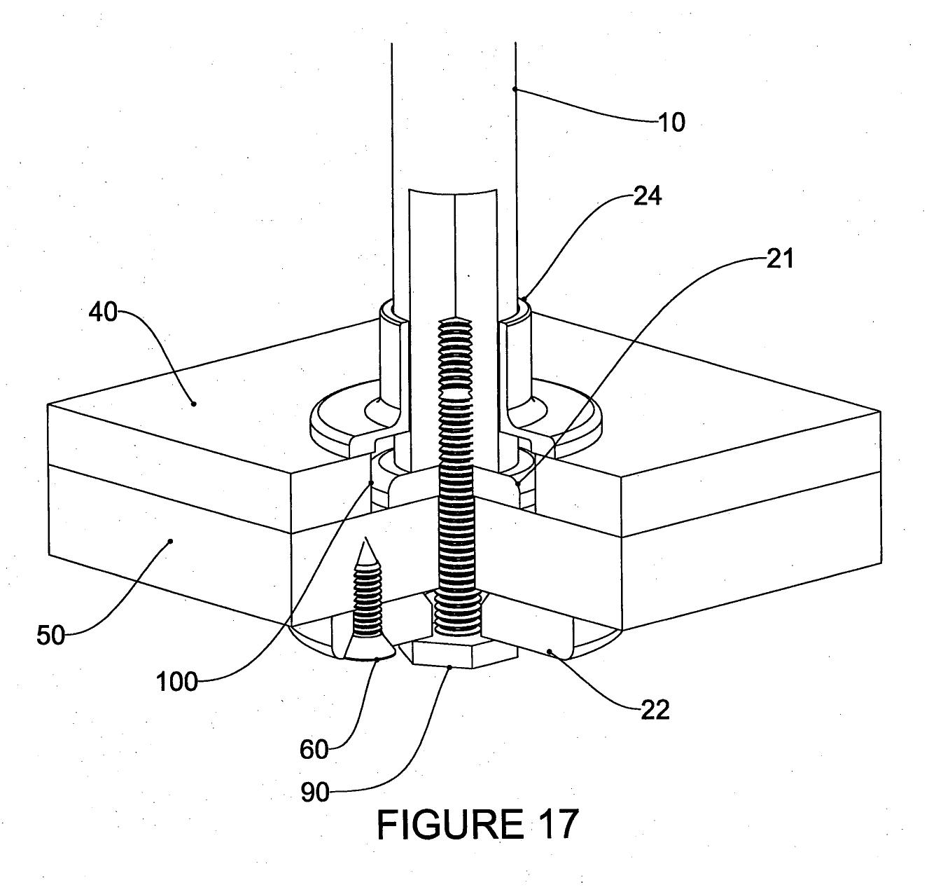

FIG. 17 shows an example concealed mount embodiment using a support rod 10 passing through a first flange 24 and sitting on a second flange 21 recessed in the hard surface 40 sitting in a clearance hole 100. The post 10 is also attached to a flange 22 on the bottom of the surface 50. The post 10 is connected to the first 24, second 21, and third flanges 22 by a bolt 90 passing through the third flange 22, second flange 21, and the surface 40, 50. The third flange 22 is attached to the bottom of the surface 50 with screws 60. The surface in FIG. 17 can be a solid surface top, for example. Surface 40 can be a typical solid surface and surface 50 a typical underlay.

Benefits of the modular system of the present invention include
allowing stocking of several interchangeable parts that are readily available should on site mounting conditions change;
allowing changing of mounting hardware before, during and after installation;
allowing end user to change shape of mounting hardware after installation should they choose to move product to a different location or relocate supports;
allowing end user to change slope angle of the product before, during or after installation;
if product is received at job site and will not fit because of equipment constraints and/or relocation, mounting hardware can be changed to accommodate the specific condition;
below counter mount can be changed to surface mount if casework/cabinet cannot be drilled through because of wiring below cabinet, etc.;
job sites with existing casework may have combination of countertop surfaces all requiring different mounts;
if one mounting method after installation proves to be shaky or unstable a different method may be applied on site without the need to replace all the equipment, modifications and change out can take place quickly and with little effort;
height of supports can also be made taller by adding spacer after, before, during installation process;
can be mounted to walls, ceilings, soffits, cabinets; even or uneven surfaces;
allowing for flexibility of food protection by enabling user to change top section of unit depending on application; and
reuse of components when changing configuration.

Other advantages to the supplier include
Stocking a single support rod with drilled/tapped base to accommodate any type of mounting hardware including
Pass-through collar-type flange,
Surface mount bolt on flange,
Angled, surface mount bolt on flange.

Throughout this application, various publications are referenced. The disclosures of these publications in their entireties are hereby incorporated by reference into this application in order to more fully describe the apparatuses and methods described herein.

Various modifications and variations can be made to the apparatuses and methods described herein. Other aspects of the apparatuses and methods described herein will be apparent from consideration of the specification and practice of the apparatuses and methods disclosed herein. It is intended that the specification be considered as exemplary.

1. A support post of a food guard, the post being essentially solid, having two ends, and having at least one end with a threaded opening therein.

2. The support post of claim 1 wherein the threaded opening is in an end surface of the post.

3. The support post of claim 1 wherein the threaded opening is essentially centered in the end surface of the post and is along the longitudinal axis of the post.

4. The support post of claim 1 wherein the post is configured to couple to a flange.

5. The support post of claim 1 wherein there is a threaded opening in each end surface of the post.

6. The support post of claim 1 further having at least one opening along the length of the post.

7. The support post of claim 6 wherein the at least one opening along the length of the post is threaded.

8. A flange that couples to the support post of claim 1 by means of a threaded fastener that secures directly to the threaded opening of the support post.

9. A support post of a food guard comprising a solid rod having two ends and having at least one threaded opening in at least one end.

10. A modular system for assembling food guards comprising
at least one support post wherein the support post comprises a solid rod having two ends and having at least one threaded opening in at least one end,
at least one flange,
wherein the at least one flange is configured to be removably secured to the at least one support post.

11. The modular system for assembling food guards of claim 10 wherein the system comprises multiple support rods and multiple flanges.

12. The modular system for assembling food guards of claim 10 further comprising at least one spacer.

13. The modular system for assembling food guards of claim 10 further comprising at least one bracket.

14. The modular system for assembling food guards of claim 10 further comprising at least one shield.

15. The modular system for assembling food guards of claim 10 further comprising at least one shelf.

16. A kit for assembling food guards comprising
at least one solid support post having two ends, and having at least one end with a threaded opening therein,
at least one flange,
at least one bracket,
at least one shield or shelf,
wherein the flange, bracket, and shield or shelf are configured to be removably secured to the at least one support post interchangeably.

17. The kit of claim 16 further comprising at least one spacer.

18. A food guard comprising
at least one solid support post having two ends, and having at least one end with a threaded opening therein,
at least one flange,
at least one bracket,
at least one shield or shelf,
wherein the flange, bracket, and shield or shelf are configured to be removably secured to the at least one support post interchangeably.

19. A method of converting a modular food guard from a first configuration to a second configuration, comprising
providing a modular system for assembling food guards comprising
at least one support post wherein the support post comprises a solid rod having two ends and having at least one threaded opening in at least one end,
at least one flange,
wherein the at least one flange is configured to be removably secured to the at least one support post;
removing undesired components of the first configuration of the food guard;
re-assembling and/or replacing the components of the food guard using components from the modular system thereby forming a second configuration of a food guard.

20. A method of assembling a modular food guard comprising
providing a modular system for assembling food guards comprising
at least one support post wherein the support post comprises a solid rod having two ends and having at least one threaded opening in at least one end,
at least one flange,
wherein the at least one flange is configured to be removably secured to the at least one support post;
attaching components of the modular system together in a desired end configuration of a food guard.
